(19) United States
(12) Patent Application Publication
(10) Pub. No.: US 2024/0040432 A1
(43) Pub. Date: Feb. 1, 2024

(54) METHOD OF POLICY EXCHANGE FOR ATSSS OVERLAY AND SYSTEM

(71) Applicant: DEUTSCHE TELEKOM AG, Bonn (DE)

(72) Inventors: Markus AMEND, Nidda (DE); Ahmed HAFEZ, Duesseldorf (DE)

(21) Appl. No.: 18/256,930

(22) PCT Filed: Oct. 19, 2021
(86) PCT No.: PCT/EP2021/078900

§ 371 Date: Jun. 12, 2023

(30) Foreign Application Priority Data
Dec. 14, 2020 (EP) 20 213 792.3

(51) Int. Cl. H04W 28/08; H04W 76/16

(52) U.S. Cl. CPC H04W 28/0925; H04W 76/16

(57) ABSTRACT

A communication system includes: a policy entity for an Access Traffic Steering, Switching and Splitting (ATSSS) Overlay; a mobile core; a User Equipment (UE); and a multi-connectivity provider having a multi-connectivity termination point. The ATSSS Overlay is configured to provide multi-connectivity without an ATSSS user plane function. The policy entity is configured to communicate ATSSS Overlay specific rules with the UE and/or to the multi-connectivity termination point.

### CROSS-REFERENCE TO PRIOR APPLICATIONS

This application is a U.S. National Phase application under 35 U.S.C. § 371 of International Application No. PCT/EP2021/078900, filed on Oct. 19, 2021, and claims benefit to European Patent Application No. EP 20 213 792.3, filed on Dec. 14, 2020. The International Application was published in English on Jun. 23, 2022 as WO 2022/128209 A1 under PCT Article 21(2).

### FIELD

This invention relates to a method of policy exchange for Access Traffic Steering Switching Splitting (ATSSS) Overlay and a system thereof.

### BACKGROUND

Typically, Internet network operators provide one or several access like fixed (e.g. xDSL), Wi-Fi (e.g. public Hotspots) or cellular (e.g. 2G-5G) to customers. Even if those customers own user equipment (UE) like smartphones, which are potentially capable of connecting to multiple accesses simultaneously, they do not make use of this capability due to the lack of multi-connectivity technologies. For smartphones, this is the common simultaneous availability of Wi-Fi and cellular network, where applications are stuck to one access and unable to benefit from a second available access in terms of reliability and speed.

Network protocols which could leverage the potential of multiple accesses like Multipath Transmission Protocol (MPTCP), Multipath Quick UDP Internet Connection (MP-QUIC), Multipath Datagram Congestion Control Protocol (MPDCCP) and Stream Control Transmission Protocol (SCTP) are not widely adopted and require usually an end-to-end implementation. A broad and fast availability is therefore unrealistic.

Standardized multi-connectivity architectures like 3GPP Access Traffic Steering Switching Splitting (ATSSS) part of 3GPP Rel. 16 standardization TS 23.501, version 16.5.0, 9 Jul. 2020, promise to provide remedy and use such protocols between a UE and a Mobile Network Operator (MNO). Furthermore, these architectures give the operator(s) of such architectures a comprehensive traffic management capability.

The ATSSS manages simultaneous connectivity for UEs over cellular (3GPP access) and non-cellular access (e.g. untrusted non-3GPP access—3rd party Wi-Fi) and is depicted in FIG. 1.

FIG. 1 illustrates an exemplary ATSSS architecture as defined by the 3GPP TS 23.501. In FIG. 1, the ATSSS manages simultaneous connectivity for UEs over cellular (3GPP access) and non-cellular access (untrusted non-3GPP access, e.g. Wi-Fi). As shown in FIG. 1, the UE connects to a Data Network (DN) over cellular (3GPP Access) and Wi-Fi (Untrusted Non-3GPP access) using the N3 interface towards the ATSSS-UPF (User Plane Function) part of a 5G Core.

The UPF can be understood as the interface between the UE and the Data Network (e.g. the Internet) taking responsibility for traffic management. Other entities/functions forming part of the 5G Core as shown in FIG. 1 are: Access and Mobility Management Function (AMF), Session Management Function (SMF) and Policy Control Function (PCF). Further, FIG. 1 also shows the name of the interfaces that are exposed by each of these entities.

An important feature of the ATSSS architecture is the policy framework coming along, to exchange rules for traffic management leveraging the 5G control plane. In the 5G core, the PCF is responsible to provide the ATSSS related policies via the N4 interface to the ATSSS UPF or via NAS to the UE. The PCF controls:
The Steering Mode that is used to steer/switch/split the detected Service Data Flow (SDF).
The Steering Functionality that is used for the detected SDF, e.g. the MPTCP functionality or the ATSSS-LL functionality.
Charging information depending on what Access Type is used for a detected SDF.
Usage Monitoring information depending on what Access Type is used for a detected SDF.

Information around PCF that are more detailed can be found in 3GPP Rel. 16 standardization TS 23.501, version 16.5.0, 9 Jul. 2020, Section 6.1.3.20.

Furthermore, according to 3GPP TS 23.501, the ATSSS requires a 5GC and cannot be integrated in a 4G core (EPC). Moreover, the ATSSS interworking between 4G and 5G is not supported due to the lack of proper Multiple Access Protocol Data Unit (MA PDU) handling. These limitations might lead to a delayed introduction of ATSSS.

The above limitations may be overcome by introducing a partial integration of the ATSSS, as exemplary shown in FIG. 2 and referred in this document to as “ATSSS Overlay”. The ATSSS Overlay differentiates from an ATSSS as defined by the 3GPP in that it provides multi-connectivity without an ATSSS user plane function.

FIG. 2 illustrates a User Equipment (UE) 1 (supporting ATSSS capabilities) that is connected to a Data Network (DN) 2 through a multipath. One path uses the 4G/5G Radio Access Network (RAN) whereas the other path uses WiFi/Fixed core. Both paths are connected to the ATSSS Overlay. The ATSSS Overlay is characterized by at least multipath support, with a new backend entity resembling on backend side the ATSSS UPF, while not requiring the same integration level.

In other words, that means that the backend component can also be located at a Mobile virtual network operator (MVNO), a multi-connectivity provider with or without its own access resources, at a mobile network operator (MNO) with EPC, at a MNO without the coupling with fundamentals core components as e.g. SMF, AMF, PCF, at a fixed network operator (FNO), or in a public cloud environment.

Referring again to FIG. 2, the ATSSS Overlay provides an alternative to 3GPP TS 23.501, supporting similar user plane mechanisms. However, the ATSSS Overlay lacks support for the control plane in 3GPP TS 23.501 combined with the ATSSS policies exchange.

An already established mechanism to exchange tariff- and subscription-based information between a MNO and an UE is the Entitlement Server described in TS.43 Service Entitlement Configuration, Version 5.0, 3 Apr. 2020. In this document, entitlements for Voice-over-Wi-Fi (VoWiFi), Voice-over-LTE (VoLTE), SMS over IP (SMSoIP) and On-Device Service Activation (ODSA), e.g. for eSIM are specified. Multiple authentication schemes in the mentioned document support identification of an UE and/or customer giving the opportunity to provide very dedicated entitlements and even policies.

However, currently there is not support for ATSSS Overlay by the Entitlement Server.

### SUMMARY

In an exemplary embodiment, the present invention provides a communication system. The communication system includes: a policy entity for an Access Traffic Steering, Switching and Splitting (ATSSS) Overlay; a mobile core; a User Equipment (UE); and a multi-connectivity provider having a multi-connectivity termination point. The ATSSS Overlay is configured to provide multi-connectivity without an ATSSS user plane function. The policy entity is configured to communicate ATSSS Overlay specific rules with the UE and/or to the multi-connectivity termination point.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates principles of a 3GPP ATSSS architecture according to the prior art.

FIG. 2 illustrates principles of an ATSSS Overlay architecture according to the prior art.

FIG. 3 illustrates an exemplary over-the-top ATSSS Overlay independent from network operators, according to an embodiment of the present invention.

FIG. 4 illustrates an exemplary ATSSS Overlay with a MNO providing access, multipath traffic management and an Entitlement server, according to an embodiment of the present invention.

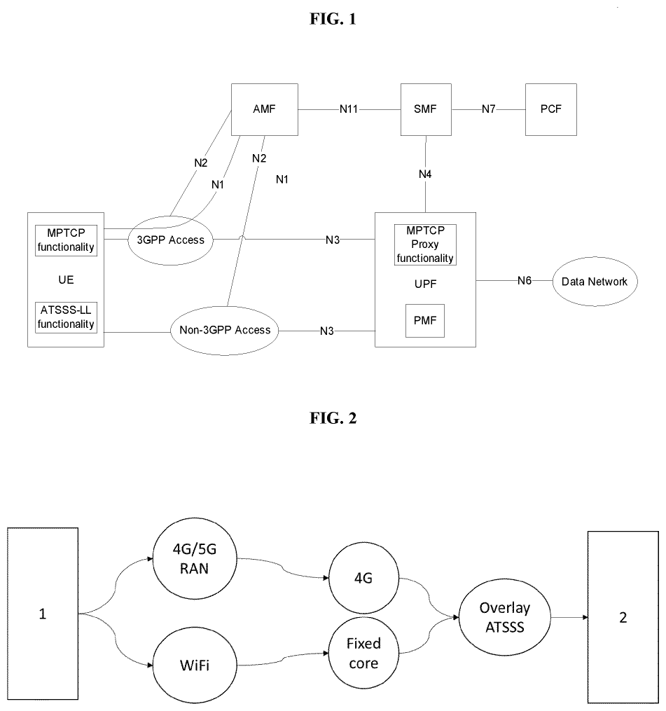

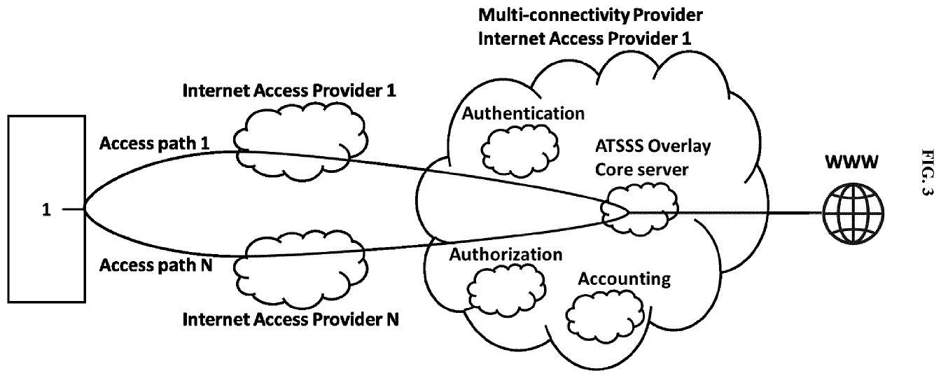

### DETAILED DESCRIPTION

Exemplary embodiments of the present invention provide a policy entity for an ATSSS Overlay with a policy mechanism. Preferably, the policy entity provides an out-of-band policy mechanism, which is decoupled from the user plane provisioning.

In an exemplary embodiment, the invention extends the Entitlement Server with support for ATSSS Overlay.

In an exemplary embodiment, the invention defines ATSSS Overlay specific rules/policies, such as: in a 5GC PCF or a EPC PCRF and/or in the Entitlement Server or in the interconnected BSS and/or in a new entity residing in the core.

In an exemplary embodiment, the invention provides requesting UEs with ATSSS Overlay specific rules/policies.

According to an aspect of the invention, there is provided a communication system comprising a policy entity for an Access Traffic Steering, Switching and Splitting (ATSSS) Overlay, a mobile core, a User Equipment (UE), and a multi-connectivity provider having a multi-connectivity termination point, wherein the ATSSS Overlay is configured to provide multi-connectivity without an ATSSS user plane function, wherein the policy entity is configured to communicate ATSSS Overlay specific rules with the UE and/or to the multi-connectivity termination point.

In other words, the above-mentioned feature that the ATSSS Overlay provides multi-connectivity without an ATSSS user plane function means that the ATSSS Overlay is independent from a 3GPP defined ATSSS or independent from a 3GPP defined mobile core.

According to a preferred aspect, the policy entity is configured to communicate with the UE and/or the multi-connectivity termination point using an out-of-band communication.

According to a preferred aspect, the ATSSS Overlay specific rules comprise one or more of the following parameters: an indication whether the ATSSS Overlay is enabled or disabled; information regarding an ATSSS Overlay Core Server comprising IP address, port number, and/or Fully Qualified Domain Name (FQDN); ATSSS Overlay Traffic management rules for steering, switching and splitting; ATSSS Overlay coverage information comprising application information, destination address information, locality information, network protocol information, environment information.

According to a preferred aspect, the system further comprises a policy entity for ATSSS as defined by the 3GPP, so that the policy entity for the ATSSS Overlay co-exists in the communication system with the policy entity for the ATSSS as defined by the 3GPP.

According to a preferred aspect, the policy entity for the ATSSS Overlay is further configured to communicate ATSSS Overlay specific rules towards the policy entity for the ATSSS.

According to a preferred aspect, the policy entity for the ATSSS is configured to communicate ATSSS rules towards the policy entity for the ATSSS Overlay.

According to a preferred aspect, the mobile core is configured to inform the UE of the availability of the ATSSS Overlay.

According to a preferred aspect, the policy entity for the ATSSS Overlay is an entitlement server.

According to another aspect of the invention, there is provided a method for exchanging policies by a policy entity within an Access Traffic Steering, Switching and Splitting (ATSSS) Overlay in a communication system, the communication system comprising a mobile core, a User Equipment (UE), and a multi-connectivity provider having a multi-connectivity termination point, wherein the ATSSS Overlay provides multi-connectivity without an ATSSS user plane function, the method comprising: communicating, from the policy entity, ATSSS Overlay specific rules to the UE and/or to the multi-connectivity termination point.

In other words, the above-mentioned feature that the ATSSS Overlay provides multi-connectivity without an ATSSS user plane function means that the ATSSS Overlay is independent from a 3GPP defined ATSSS or independent from a 3GPP defined mobile core.

According to a preferred aspect, the policy entity communicates with the UE and/or the multi-connectivity termination point using an out-of-band communication.

According to a preferred aspect, the ATSSS Overlay specific rules comprise one or more of the following parameters: an indication whether the ATSSS Overlay is enabled or disabled; information regarding an ATSSS Overlay Core Server comprising IP address, port number, and/or Fully Qualified Domain Name (FQDN); ATSSS Overlay Traffic management rules for switching, switching and splitting; ATSSS Overlay coverage information comprising application information, destination address information, locality information, network protocol information, environment information.

According to a preferred aspect, the system further comprises a policy entity for ATSSS as defined by the 3GPP, so that the policy entity for the ATSSS Overlay co-exists in the communication system with the policy entity for the ATSSS as defined by the 3GPP.

According to a preferred aspect, the policy entity for the ATSSS Overlay communicates ATSSS Overlay specific rules towards the policy entity for the ATSSS.

According to a preferred aspect, the policy entity for the ATSSS communicates ATSSS rules towards the policy entity for the ATSSS Overlay.

According to a preferred aspect, the mobile core informs the UE of the availability of the ATSSS Overlay.

According to a preferred aspect, the policy entity for the ATSSS Overlay is an entitlement server.

Other aspects, features, and advantages will be apparent from the summary above, as well as from the description that follows, including the figures and the claims.

The following description and figures assume a User Equipment (UE) such as, for example, a smartphone, or Residential Gateway (RG), equipped with Wi-Fi and cellular access interfaces or fixed such as DSL and cellular access interfaces. However, this can be transferred to any other multi-connectivity scenario with more or other accesses.

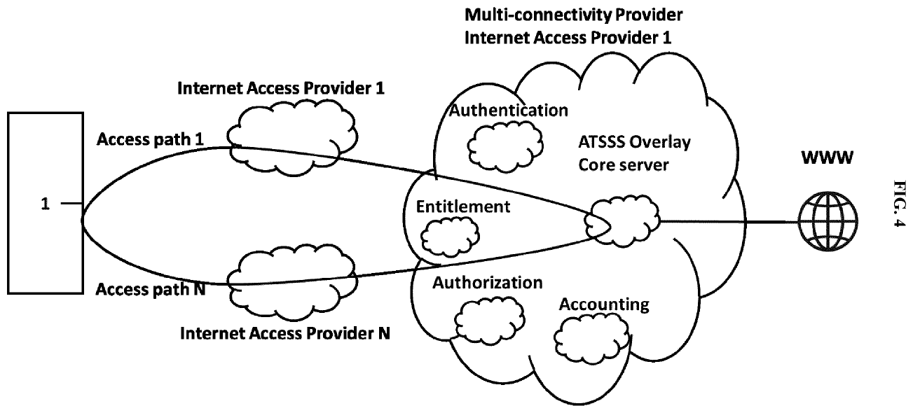

FIG. 3 illustrates an exemplary over-the-top ATSSS Overlay independent from network operators, according to an embodiment of the present invention. In that context, an ATSSS Overlay is provided from a multi-connectivity provider without assets in the access operator networks.

Alternatively, the ATSSS Overlay may be combined with a Mobile Network Operator (MNO) providing access and multipath traffic management.

The less integrated multi-connectivity network as shown in FIG. 3 is characterized by at least multipath support, with a new backend entity, also referred to in the following description as ATSSS Overlay Core Server, resembling on backend side the ATSSS UPF, while not requiring the same integration level. In particular that means that the new backend component can also be located at a Mobile virtual network operator (MVNO), a multi-connectivity provider with or without own access resources, at a mobile network operator (MNO) with EPC, at a MNO without the coupling with fundamentals core components as e.g. SMF, AMF, PCF, at a fixed network operator (FNO), or in a public cloud environment.

Preferably, the new backend entity is compared to the ATSSS UPF, a lightweight implementation with only some of the functionalities or different functionalities. Multipath protocols supported might be similar to ATSSS UPF MPTCP or others like MP-DCCP, MP-QUIC, QUIC, SCTP.

In any case, partial integration of the ATSSS, hereinafter referred to as ATSSS Overlay, it is not required that all accesses are owned by the multi-connectivity provider.

FIG. 4 illustrates an exemplary ATSSS Overlay with a Mobile Network Operator (MNO) providing access, multipath traffic management and an Entitlement server, according to an embodiment of the present invention.

Some possible ATSSS Overlay specific rules/policies provided by the policy entity due to subscription information may comprise: 1) general: Enabled/Disabled ATSSS Overlay; 2) ATSSS Overlay Core Server: IP address (:Port)/FQDN; 3) ATSSS Overlay Traffic management rule: Steering/Switching/Splitting; 4) ATSSS Overlay coverage: Application (e.g. Name), Destination (IP address/Port/AS), Locality (Coordinates, connected base station, . . . ), Network protocol (e.g. TCP/UDP), Environment (CAMPUS/Public/Roaming).

The ATSSS Overlay coverage means that is either applied to any traffic or selected traffic given by the ATSSS Overlay policies.

The rules in 1)-4) can be combined arbitrarily and provided as a set of rules. The detection of the policy entity follows the rules according to TS.43 Service Entitlement Configuration, Version 5.0, 3 Apr. 2020, Chapter 2. The client, i.e. the UE, may follow a discovery procedure to obtain the address of the entitlement configuration server, with a resulting FQDN based on the following format: aes.mnc<MNC>.mcc<MCC>.pub.3gppnetwork.org.

The UE is configured to implement a method to interpret the ATSSS related policies played out by the policy entity.

Leveraging existing functions in the 4G core and/or the 5G core related to the policy frameworks PCRF/PCF, allow the definition of ATSSS rules (partially) maintained in these entities. This also facilitates the compatibility with the fully fledged ATSSS from 3GPP Technical Specification: 23.501, Version 16.5.0, 9 Jul. 2020.

In that case this invention further claims the exchange of information from/to PC(R)F to/from the policy entity. This is in particular useful if ATSSS and ATSSS-Overlay co-exists. In this case it may be beneficial to maintain the ATSSS related policies or a subset of them at one location instead of maintaining them on different locations (PC(R)F and policy entity). Linking the different policy entities allows to specify policies at one of them and replicate them to the other.

In case the policies have to be provided from a new defined core entity which are not defined yet like PC(R)F or policy entity, it becomes crucial that the UE becomes aware of the policy entity. 3GPP responsible for 4G core and 5GC as well as GSMA specifying the Entitlement Server have established processes, e.g. TS.43 Service Entitlement Configuration, Version 5.0, 3 Apr. 2020, Chapter 2. At least the latter proposes a simple approach being available under a specified Fully Qualified Domain Name (FQDN) which can be verified by an UE. Preferably the same approach can be adopted by the policy entity (which in some cases may be the same as the Entitlement Server). Another mechanism uses the existing policy framework (e.g. PC(R)F) of a MNO and the connected UEs to communicate the existence of the policy entity.

According to an embodiment, another approach could be the usage of (hidden) SMS to announce the availability from the network.

The reason for a new defined policy entity, possibly dedicated to the task for the out-of-band ATSSS Overlay policy exchange, may be much simpler and with less complexity compared to the PC(R)F or Entitlement Server. This is because PC(R)F and Entitlement Servers are relatively complex and oversized when only some ATSSS overly policies are required. That might become crucial for small/limited networks like CAMPUS/Enterprise.

While the invention has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made by those of ordinary skill within the scope of the following claims, which may include any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

Furthermore, in the claims the word “comprising” does not exclude other elements or steps, and the indefinite article “a” or “an” does not exclude a plurality. A single unit may fulfill the functions of several features recited in the claims. The terms “essentially”, “about”, “approximately” and the like in connection with an attribute or a value particularly also define exactly the attribute or exactly the value, respectively. Any reference signs in the claims should not be construed as limiting the scope.

1. A communication system, comprising:
a policy entity for an Access Traffic Steering, Switching and Splitting (ATSSS), Overlay;
a mobile core;
a User Equipment (UE); and
a multi-connectivity provider having a multi-connectivity termination point;
wherein the ATSSS Overlay is configured to provide multi-connectivity without an ATSSS user plane function; and
wherein the policy entity is configured to communicate ATSSS Overlay specific rules with the UE and/or to the multi-connectivity termination point.

2. The communication system of claim 1, wherein the policy entity is configured to communicate with the UE using an out-of-band communication.

3. The communication system of claim 1, wherein the policy entity is configured to communicate with the multi-connectivity termination point using an out-of-band communication.

4. The communication system of claim 1, wherein the ATSSS Overlay specific rules comprise one or more of the following parameters:
an indication of whether the ATSSS Overlay is enabled or disabled;
information regarding an ATSSS Overlay Core Server comprising IP address, port number, and/or Fully Qualified Domain Name (FQDN);
ATSSS Overlay Traffic management rules for steering, switching and splitting; and/or
ATSSS Overlay coverage information comprising application information, destination address information, locality information, network protocol information, and/or environment information.

5. The communication system of claim 1, wherein the communication system further comprises:
a policy entity for ATSSS as defined by the 3GPP;
wherein the policy entity for the ATSSS Overlay co-exists in the communication system with the policy entity for the ATSSS as defined by the 3GPP.

6. The communication system of claim 5, wherein the policy entity for the ATSSS Overlay is further configured to communicate ATSSS Overlay specific rules towards the policy entity for the ATSSS as defined by the 3GPP.

7. The communication system of claim 5, wherein the policy entity for the ATSSS as defined by the 3GPP is configured to communicate ATSSS rules towards the ATSSS Overlay policy entity.

8. The communication system of claim 5, wherein the mobile core is configured to inform the UE of the availability of the ATSSS Overlay.

9. The communication system of claim 1, wherein the policy entity for the ATSSS Overlay is an entitlement server.

10. A method for exchanging policies by a policy entity within an Access Traffic Steering, Switching and Splitting (ATSSS) Overlay in a communication system, the communication system comprising a mobile core, a User Equipment (UE), and a multi-connectivity provider having a multi-connectivity termination point, wherein the ATSSS Overlay provides multi-connectivity without an ATSSS user plane function, the method comprising:
communicating, from the policy entity, ATSSS Overlay specific rules to the UE and/or to the multi-connectivity termination point.

11. The method of claim 10, wherein the policy entity communicates with the UE using an out-of-band communication.

12. The method of claim 10, wherein the policy entity communicates with the multi-connectivity termination point using an out-of-band communication.

13. The method of claim 10, wherein the ATSSS Overlay specific rules comprise one or more of the following parameters:
an indication of whether the ATSSS Overlay is enabled or disabled;
information regarding an ATSSS Overlay Core Server comprising IP address, port number, and/or Fully Qualified Domain Name (FQDN);
ATSSS Overlay Traffic management rules for switching, switching and splitting; or
ATSSS Overlay coverage information comprising application information, destination address information, locality information, network protocol information, and/or environment information.

14. The method of claim 10, wherein the communication system further comprises a policy entity for ATSSS as defined by the 3GPP, and wherein the policy entity for the ATSSS Overlay co-exists in the communication system with the policy entity for the ATSSS as defined by the 3GPP.

15. The method of claim 14, wherein the policy entity for the ATSSS Overlay communicates ATSSS Overlay specific rules towards the policy entity for the ATSSS as defined by the 3GPP.

16. The method of claim 14, wherein the policy entity for the ATSSS as defined by the 3GPP communicates ATSSS rules towards the policy entity for the ATSSS Overlay

17. The method of claim 10, wherein the mobile core informs the UE of the availability of the ATSSS Overlay.

18. The method of claim 10, wherein the policy entity for the ATSSS Overlay is an entitlement server.
